(19) United States
(12) Patent Application Publication
(10) Pub. No.: US 2006/0210364 A1
(43) Pub. Date: Sep. 21, 2006

(54) Cutting element and tool equipped with at least one cutting element

(75) Inventors: Bernhard Bellmann, Ruckersdorf (DE); Helmut Glimpel, Lauf a.d. Pegnitz (DE)

Correspondence Address: KATHLEEN T. PETRICH;STOKES LAWRENCE, P.S., 800 FIFTH AVENUE, SUITE 4000, SEATTLE, WA, 98104-3179, US

(73) Assignee: EMUGE-Werk Richard Glimpel GmbH & Co. KG Fabrik fur Prazisionswerkzeuge

(21) Appl. No.: 11/438,894

(22) Filed: May 22, 2006

Related U.S. Application Data
(63) Continuation of application No. PCT/EP04/12826, filed on Nov. 12, 2004.

(30) Foreign Application Priority Data
Dec. 23, 2003 (DE) 103 61 450.8

(51) Int. Cl. B23C 5/20

(52) U.S. Cl. 407/40; 407/113

(57) ABSTRACT

A cutting element having a first upper surface (20) and at least one lateral surface (23), whereby the lateral surface and the first upper surface meet in an edge area (24). At least one cutting edge (11 to 14) is formed on the edge area. Each cutting edge is, in essence, convexly curved with regard to a rotation axis (A) extending through the cutting element. The curvature of each cutting edge increases in a strictly monotonous manner in a predetermined direction of rotation (D) about the rotation axis.

### RELATED APPLICATION

The present application claims priority to PCT International Application Serial No. PCT/EP2004/012826, filed Nov. 12, 2004, and entitled “Cutting Element and Tool Equipped With at Least One Cutting Element,” which claims priority to German Patent No. 103 61 450.8, filed Dec. 23, 2003.

### TECHNICAL FIELD

The invention relates to a cutting element and to a tool with at least one cutting element.

### BACKGROUND OF THE INVENTION

The geometry of a cutting part or cutting element of a tool that operates by the removal of material or chips is generally described with reference to certain terms that will be briefly detailed below; the present application also employs these terms according to the following definitions, which to a great extent are derived from the book by A. Herbert Fritz and Günter Schulze, “Fertigungstechnik” , 5th Edition, 2001, Springer Verlag/VDI.

The “face” or “chip surface” or “cutting face” of the cutting part is the surface over which the removed chip passes during the material-removing process. The “flanks” or “free surfaces” are the surfaces of the cutting part that are turned towards the cut surfaces produced in the workpiece. The cutting lines, one-dimensional structures formed by the intersection of the faces and flanks, are the “cutting edges” of the tool. The “major cutting edges” (or main cutting edges) are aimed in the direction in which the tool is advanced within the plane of operation, whereas the “minor cutting edges” (or secondary cutting edges) are not. At a “corner” or “nose” the major cutting edges and minor cutting edges coincide with the face. This corner of the tool is often rounded or chamfered.

The “tool angles” are determined by the orientation or position of the surfaces of the cutting part with respect to one another, and are measured within the so-called.tool reference system. The tool angles thus characterize the geometry of the cutting part and are significant for the manufacture and maintenance of the tools. It is important to distinguish the tool angles from the “working angles” measured in the working reference system in order to represent the cutting or chip-removing process. The tool reference system includes not only a tool reference plane, which passes through the cutting-edge point under consideration perpendicularly, as nearly as possible, to the assumed cutting direction and is oriented according to a plane, axis or edge of the tool, which in the case of an end-milling cutter is the axis of rotation, but also a cutting edge plane that contains the cutting edge as well as a reference plane of the cutting edge. In the working reference system the tool reference plane is replaced by the working reference plane, which is considered to be perpendicular to the working direction or effective direction of cut. In each of the two reference systems, the three planes are perpendicular to one another.

In the tool reference system the angles most important for the cutting process are the rake angle, which corresponds to the angle between the face and the tool reference plane, the wedge angle, which corresponds to the angle between face and flank, and the clearance angle or relief angle, which corresponds to the angle between flank and cutting edge plane of the tool. The sum of the three angles is 90°. Other angles of interest are the setting angle or cutting edge angle, which is measured between the cutting edge plane of the tool and the working plane in the tool reference plane, and the included angle, which is measured between the cutting edge planes of associated major and minor cutting edges in the tool reference plane. Finally, the cutting-edge inclination angle in the tool cutting edge plane is defined as the angle between cutting edge and tool reference plane.

The known cutting techniques, especially the milling techniques, employ cutting parts having many different geometries and forms. In particular, some are designed to be exchangeable and can be used several times; these cutting elements (or cutting plates, cutting inserts) comprise two or more cutting regions that are substantially the same as or congruent with one another and can be used several times by turning or rotating them with respect to the carrier element, depending on the number of identical cutting edges that are present. As a rule, in this case the cutting edges are disposed in accordance with a pre-specified n-fold rotational symmetry, so that because of this symmetry the cutting part coincides with itself in its previous position when rotated through a pre-specified angle or an integral multiple of that angle. In the case of two cutting edges, as a rule a rotational angle of 180° is selected; for three cutting edges the rotational angle is 120° and for four cutting edges the rotational angle is 90°, etc. That is, in general the angle of rotation is 360° , where “n” is the integral number of symmetry. A cutting insert designed to be rotated in this way, with n-fold symmetry, can be employed by turning about the rotational angle “n” times before it must finally be exchanged for another insert. Depending on the type of application, widely different forms of such rotational cutting inserts are known. Some have linearly oriented cutting edges, which intersect at pointed comer regions, whereas in other cases the tool has curved cutting edges, corresponding to a flat or similarly curved shape of the faces and flanks, as is known for example from US 4,294,565 A, EP 1 075 889 A1, DE 100 52 963 A1, DE 199 56 592 A1 or EP 1 260 298 A1.

The document US 4,294,565 A discloses a cutting insert to be used with a milling tool for the purpose of finishing; the insert comprises two flat surfaces or rake surfaces, which are parallel to one another, and cutting edges on the front rake surface. Between the two rake surfaces are formed trapezoidal edge faces, which are disposed at an acute angle relative to a plane normal to the rake surface of the finishing insert. Because the edge faces are inclined at this angle, a clearance angle is allowed when the insert is disposed at a positive axial inclination, i.e. is inclined in the direction of rotation of the tool on the radially outer side of the cutting plate. The front and rear rake surfaces have a polygonal shape with sides of equal length, in particular a quadratic shape, and hence have four-fold rotational symmetry with four main cutting edges. These main cutting edges have the shape of a circular arc with a radius several times larger than the width of the front rake surface of the finishing insert. Owing to this circularly convex curvature of the cutting edges, at the corners of the cutting plate there is an offset (corner drop x), which is measured between an end point of the cutting edge and a line tangential to the midpoint (d) of the cutting edge. At the lateral surfaces of this known finishing insert convexly curved indents are provided for the purpose of clamping the insert within its pocket on the body of the tool. In the case of this known finishing insert according to US 4,294,565 A the part used for milling or cutting is not a comer region of the cutting plate, but rather the edge region of the quadratic basic structure that surrounds the center point of the cutting edge.

From DE 100 52 963 A1 a face milling and cutting tool is known with several disposable cutting plates, which are releasably fixed within cutting-plate receptacles in an elongated main body of the tool. The disposable cutting plates are polygonal plates, each of which comprises a comer cutting edge in at least one part thereof, a curved cutting edge disposed adjacent to the comer cutting edge at the front end part of the main tool body, and a peripheral cutting edge disposed on another side of the corner cutting edge on an outer side of the main tool body; the arrangement is such that the curved cutting edge projects forward from the corner cutting edge at the front end part of the main tool body and the peripheral cutting edge extends backward in the direction towards an axis of the main tool body. The curved cutting edge has a fixed radius of curvature and hence a constant curvature. The corner cutting edge likewise has a fixed radius of curvature and hence a constant curvature. The radius of curvature of the corner cutting edge is smaller than that of the curved cutting edge. The peripheral cutting edge has a linear construction.

The document DE 199 56 592 A1 discloses a cutting plate for spherical milling cutters, which has a major cutting edge that extends in a substantially radial plane and is to be located on the face, a minor cutting edge cutter that extends mainly axially, backwards and in part radially outwards, as well as a corner cutting edge at the junction between the major and minor cutting edges, which is rounded with a particular radius as seen in a plan view of the upper surface of the cutting plate; the radius of the minor cutting edge is distinctly larger than the radius of the corner cutting edge and smaller than twice the diameter of the milling cutter for which the cutting plate is provided. The radii of curvature and hence the curvatures of the cutting edges are constant in each case.

From EP 1 075 889 A1 a cutting insert is known that has two major cutting edges disposed opposite one another and two minor cutting edges, joined to the main cutting edges, such that the cutting-edge angle is between 3° and 35°. The major cutting edge has an arcuate shape, whereas the minor cutting edge is shaped like an arc or a straight line and is inclined backward with respect to the central axis of the cutting insert. This known cutting insert comprises two corner regions with the arcuate major cutting edges and hence exhibits a two-fold symmetry and can be used twice. Furthermore, this document also discloses a cutting insert with three-fold symmetry, i.e. with three corner regions with major cutting edges, which thus is intended for triple use.

The prior art closest to the object of the present application is considered to be that according to EP 1 260 298 A1 from Hitachi. This document EP 1 260 298 A1 discloses an exchangeable cutting insert for a rotary tool that operates by the removal of material. The cutting insert has a square-shaped, front face and a square-shaped, flat back surface as well as a curved flank region on the lateral surfaces between the face and back surface. This known cutting insert has a so-called positive-type configuration, in which an outwardly curved edge line between the face and the flank region serves as cutting edge. The term “positive type” is used for a cutting insert when it in itself already comprises a clearance angle at the cutting edge for the cutting process. So that the insert can fit into the associated pocket on the rotary-tool body, in the middle of each flank region there is a flat region that extends as far as the lower or back surface, without touching the cutting edge. A major cutting edge formed by the outwardly curved edge line extends on a circular course from its lowest point to the periphery of the tool when the cutting insert is fixed to the tool with a negative radial rake angle. The radius of the outwardly curved edge line is 0.6 to 1.6 times the diameter of an in-scribed circle in the insert, and amounts to between 11 mm and 15 mm.

According to what is stated in this document EP 1 260 298 A1 the cutting insert described therein reduces the forces that act during cutting and thus increases the insert's working life.

An object of the present invention is to disclose a cutting element in which the cutting forces are still further improved, in comparison to the insert known from EP 1 260 298 A1, as well as a cutting tool with at least one such cutting element.

### SUMMARY OF THE INVENTION

The cutting element (or cutting plate or cutting insert) according to claim 1 comprises a first surface, in particular end face, and at least one lateral surface, such that the lateral surface and the first surface intersect (or meet or adjoin one another) in a marginal region (or peripheral region) and in this marginal region at least one cutting edge is formed. According to the invention, each cutting edge is now substantially convexly curved with reference to the axis of rotation, in such a way that its curvature increases strictly monotonically in the pre-specified direction of rotation about said axis of rotation. Owing to the strictly monotonic increase in curvature, the curvature at a second cutting edge point, which follows a first cutting edge point in the pre-specified direction of rotation, is always greater than the curvature at the first cutting edge point.

These measures in accordance with the invention offer several advantages. First, at a given pre-specified insertion or engagement depth, which is determined by forward feed of the tool prior to the infeed motion towards the workpiece, the insertion or engagement length of the operational or cutting edge, i.e. the length of the cutting edge that will be in contact with the workpiece during cutting, is shorter than is the case for the cutting element known from EP 1 260 298 A1, because of the progressively increasing curvature of the cutting edges in the present invention. As a result the cutting or chip-removing forces that are applied, the introduction of heat and the tendency to oscillate are further reduced in comparison to EP 1 260 298 A1and the working life is further increased. Furthermore, in the case of small engagement depths, e.g. during smoothing or finishing work, the cutting edge is effective in a region of slight curvature or near-linearity, which enables a minimal engagement length and a high quality and smoothness of the surface in the workpiece or a good leveling of furrows caused by the forward feed movement, even when that movement occurs at high speeds. However, because of its increasing curvature the cutting edge is also effective at large insertion depths, such as are employed during preliminary smoothing or rough machining, so that a cutting element with given outside dimensions can have greater insertion depths, or for a given insertion depth the cutting element can have smaller outside dimensions than is possible for the cutting element known from EP 1 260 298 A1. Hence the cutting element according to the invention is excellently suited for both final and preliminary smoothing purposes.

Advantageous embodiments, further improvements and applications of the cutting element will be apparent from the claims dependent on claim 1.

In order to achieve a cutting element for multiple use, in an especially advantageous embodiment at least two cutting edges are positioned in the marginal region, and these have identical configurations (or are congruent with one another) so that when the cutting element is turned about its axis of rotation, by a pre-specified rotational angle, the cutting edges come to occupy each other's positions (or positions where previously another cutting edge had been, in each case) and are congruent or coincide in shape with the previous cutting edge in this position. According to the number of cutting edges that are present in a marginal region, a cutting element can be used several times by taking it off, turning it about the axis of rotation, and inserting the cutting element again, since the rotation has caused the previous cutting edge to be replaced by another, which is now used for the removal of material.

The cutting edges that are identical to one another are in general provided as major cutting edges.

In one embodiment the marginal region between the cutting edges in each case comprises intermediate regions, which are not provided as (main) cutting edges and/or in particular comprise or are corner regions. The cutting edges and the adjacent intermediate regions merge continuously with one another (or meet at one point), preferably in a continuously differentiable manner (or smoothly, or meet at a point with the same inclination on both sides).

In an alternative advantageous embodiment of the cutting element, which can also be claimed independently, the marginal region comprises at least two curve sections that are identical to one another and follow one another and merge or meet continuously, preferably continuously differentiably, with one another; each of the identical curve sections is substantially convexly curved with respect to the axis of rotation, and the curvature of each of the identical curve sections increases strictly monotonically in a mutually predetermined rotational direction about the axis of rotation. Preferably in this case one of the identical cutting edges is arranged in each curve section, or each curve section corresponds substantially to one cutting edge.

The convex, monotonically increasing curvature of the cutting edges or the curve sections that comprise the cutting edges can be implemented at least in a coordinate plane perpendicular to the axis of rotation, or in a projection onto a projection plane orthogonal to the axis of rotation, with elementary functions that at least in a specified definition range and value range exhibit such behavior, or can also be composed of individual partial curves or functions on partial intervals in a continuous, preferably continuously differentiable manner, for example can be interpolated, so as to obtain an overall curve with the desired varying curvature.

As advantageous examples of elementary functions the following are cited here, with no restriction of generality:

integral rational functions or polynomials, in particular as a special case a parabola, in which case preferably each of the cutting edges ends at the summit of the parabola;

fractional rational functions or quotients of two polynomials, in particular as a special case a hyperbola, in which case preferably each of the cutting edges ends at the summit of the hyperbola;

cycloids;

elliptical functions;

trigonometric functions, in particular tangent or tangential functions or sine or sinusoidal functions;

exponential functions;

spiral functions, in particular a logarithmic spiral, a hyperbolic spiral or a spiral of Archimedes.

Likewise possible, and of equal value regarding usability for the shape of the marginal region and its cutting edges or curve sections, are functions derived from the preceding functions by a process of bijective mapping or rotation and/or shifting of its function graph, for example inverse functions such as logarithm to exponential function, square-root function to parabola, arctan to tangent, or shifted functions such as cosine to sine, etc.

It is possible to provide an odd number “n” of identical cutting edges or identical curve sections in the marginal region, in which case “n” is equal to or greater than one, in particular is three or five. Correspondingly, the symmetry of the cutting edges can then be expressed in terms of rotation about a rotational angle of 360°/n, i.e. 120° in the case of three-fold symmetry.

Likewise, the number of identical cutting edges or identical curve sections in the marginal region can also be an even number equal to or greater than two, in particular four or six. Then in terms of rotational symmetry the rotational angle of 360°/n would be, e.g., 90° in the case of four-fold symmetry or 60° for six-fold symmetry.

In a special embodiment at least the marginal region is at least approximately mirror-symmetric with respect to a plane of symmetry containing the axis of rotation, or at least approximately axially symmetric with respect to the axis of rotation. These additional symmetries can be combined in particular with embodiments having an even number “n” of cutting edges or curve sections, and/or n-fold rotational symmetry such that “n” is an even number.

The cutting edges or curve sections of the marginal region in an especially advantageous embodiment are constructed so as to be smooth or continuously differentiable. The smooth form of the individual cutting edges or curve sections and also their at least continuous and preferably likewise smooth transitions ensure that there will be less wear on the cutting element.

The cutting edges or curve sections of the marginal region can also be a composite of single partial curves, which merge with one another continuously and preferably so as to be continuously differentiable.

In a special, advantageous further development of the cutting element a marginal region is also formed on a second surface that faces away from the first surface, by the intersection of the second surface with the lateral surface.

This additional marginal region, in an advantageous further development, likewise comprises at least one cutting edge or at least two curve sections, in which case each cutting edge or curve section is substantially convexly curved with reference to an axis of rotation that passes through the cutting element, and the curvature of each cutting edge or curve section increases strictly monotonically in a pre-specified direction of rotation about the axis of rotation. Thus cutting edges in the additional marginal region can also be used, and the cutting element can be employed a correspondingly greater number of times.

In particular, this additional marginal region is preferably substantially identical to the marginal region formed by the first surface and the lateral surface; in particular, it comprises the same number, arrangement and configuration of identical cutting edges or curve sections as does the first marginal region. The number of cutting edges is thereby doubled, and so is the number of times the cutting element can be used.

As an alternative or supplementary feature, the additional marginal region is a mirror image of the first marginal region with respect to a plane of mirror symmetry situated between the first surface and the second surface, and oriented perpendicular to the axis of rotation. In particular, the rotational direction associated with the curvature of the cutting edge(s) or curve sections in the additional marginal region formed by the second surface and the lateral surface is the same as the rotational direction at the marginal region formed by the first surface and the lateral surface. Now when the cutting element is turned around, in general the tool with the cutting element must be altered so that it rotates towards the right rather than the left, or conversely.

So that the design of the tool with the cutting element does not need to be altered, two alternative especially advantageous further developments are proposed, which can also be implemented in combination. In a first one of these further developments, the additional marginal region formed by the second surface and the lateral surface originates by specular reflection (or mirroring) of the first marginal region with respect to a first plane of mirror symmetry situated between the first surface and the second surface and oriented perpendicular to the axis of rotation, and subsequent reflection (or mirroring) with respect to a second plane of mirror symmetry that contains the axis of rotation and/or by rotation of the first marginal region by 180° about an axis of symmetry oriented perpendicular to the axis of rotation. In a second one of these further developments the rotational direction determining the curvature of the blade(s) or curve sections in the additional marginal region formed by the second surface and the lateral surface is opposite to the rotational direction in the marginal region formed by the first surface and the lateral surface.

The cutting element as a whole can also be substantially mirror-symmetric with respect to a plane of symmetry situated between the first surface and the second surface and oriented perpendicular to the axis of rotation.

So that it can be fitted into a carrier body of a tool, the cutting element in an advantageous further development comprises at least one bearing surface, preferably a number of bearing surfaces corresponding to the number of cutting edges or curve sections, by way of which, when in the mounted state, it is apposed to or lies within a seating on a carrier body of the tool. Each bearing surface is formed between the two marginal regions at the lateral surface, in an embodiment with cutting edges in both marginal regions or surfaces. In embodiments with cutting edges at only one surface, each bearing surface can be spaced apart from the marginal region at the first surface and can extend as far as the second surface, or open into its marginal region. In one embodiment each bearing surface consists of one or more flat areas. If the lateral surface is curved and its curvature conforms at least predominantly to the curvature of the marginal region at the first surface or at the second surface, it is also possible to provide curved bearing surfaces. Furthermore, each bearing surface is preferably formed in a recess in the lateral surface, i.e. a structure offset inwardly from the surrounding lateral surface.

In general the marginal region, in particular its cutting edges, on the first surface forms a curve lying substantially in a plane. Similarly the additional marginal region, if present, on the second surface can be planar. Each marginal region at the first surface and/or at the second surface can comprise a bezel or chamfer, in particular to increase the wedge angle or reduce the load on the cutting edges.

To attach the cutting element to a carrier body of a cutting tool, the cutting element in a further development comprises a central opening or through-bore through which the axis of rotation passes; this bore is preferably used to accommodate a fixation means, in particular a fixing screw. However, the cutting element can also, additionally or alternatively, be clamped in place from outside by means of one or more clamping wedges.

The first surface and/or the second surface, in the region adjoining the marginal regions, runs at a solid angle that is directed inward, i.e. towards the second or first surface, respectively, and hence is correspondingly inclined at an acute angle to the lateral surface in the marginal region. As a result the marginal region has a pointed structure, with a correspondingly sharply angled cutting edge. In particular the first surface and/or the second surface comprises, between the marginal region and the bearing surface, a circumferential recess or groove to guide chips away, or serve as a chip-guiding edge.

In general when a workpiece is being machined with a cutting edge in the marginal region between first surface and lateral surface, the first surface is the cutting face and the lateral surface is the flank. Correspondingly, for machining a workpiece with a cutting edge in the marginal region between second surface and lateral surface, in general the second surface is the cutting face and the lateral surface is the flank.

Now, the cutting element can be of the positive type, comprising a clearance angle between cutting face and flank. Alternatively, the cutting element can be of the negative type, i.e. have no clearance angle (0°) between cutting face and flank, in which case as a rule a clearance angle is set as the cutting element is installed in the tool.

The cutting elements according to the invention can be made of various cutting or machining materials. The preferred materials for the cutting elements are high-speed steel or high-alloy tool steels with carbon, tungsten, molybdenum, vanadium and/or cobalt as alloy elements. The hardness of these high-speed steels or HSS steels is increased by the formation of carbides between the carbon and the carbide-forming alloy metals. Furthermore, hardening materials such as titanium carbide or titanium nitride can be applied to the cutting element as a coating, to increase its resistance to wear and tear. Another material that can be used is a hard metal, which as a rule consists of sintered systems of substances comprising metal carbides to confer the hardness and binding metals that determine toughness. Hardness is provided, for example, by tungsten carbide, titanium carbide and tantalum carbide as well as niobium carbide. The binding metals can be cobalt, nickel or molybdenum. Hard metals with very little tungsten carbide can also be used; these so-called cermets are based on titanium carbonitride. Even when a cutting element is made of hard metal a coating can be provided to increase its resistance to wear and tear. It is in principle also possible for the cutting plate to consist of a cutting ceramic, a boron nitride, in particular cubic crystalline boron nitride (CBN) or diamond, in particular polycrystal-line diamond (PCD). Polycrystalline-cubic boron nitride or polycrystalline diamond can also be used as a coating for a basic body made of hard metal.

One or more cutting elements according to the invention are generally employed in a tool, in particular a material-removing tool, with a carrier body that rotates or can be rotated about a tool axis and has one seating for each cutting element, such that the cutting element is preferably releasably attached, in particular when intended for multiple uses with several cutters, but can also be unreleasably attached, e.g. by soldering. The tool is preferably a milling tool, in particular an end-milling cutter.

These and other advantages will become more apparent upon review of the drawings, the best mode for carrying out the invention, and the claims.

### BRIEF DESCRIPTION OF THE DRAWINGS

Like reference numerals are used to designate like parts throughout the several views of the drawings, wherein:

FIG. 1 is a perspective view of a first embodiment of a cutting element with cutting edges at only one surface;

FIG. 2 is a plan view of an exemplary embodiment of a marginal region of a cutting element with four elliptical cutting edges;

FIG. 3 is a plan view of another exemplary embodiment of a marginal region for a cutting element, in which the cutting edges have a hyperbolic shape;

FIG. 4 is a plan view of another exemplary embodiment of a marginal region for a cutting element, in which sections of the curve have a parabolic shape;

FIG. 5 is a plan view of another exemplary embodiment of a marginal region for a cutting element, in which the cutting edges have a spiral shape;

FIG. 6 is a perspective view of a cutting element in which cutting edges at two surfaces are oriented with the same direction of rotation;

FIG. 7 is a perspective view of another cutting element in which cutting edges at two surfaces have the same direction of rotation;

FIG. 8 is a perspective view of a material-removing tool in which two cutting elements have been mounted;

FIG. 9 is a perspective view of the tool according to FIG. 8 after it has been rotated by 90° about its axis of rotation;

FIG. 10 shows the tool according to FIG. 8 and FIG. 9 in perspective as viewed from below or from the front;

FIG 11 shows a cutting element with five cutting edges in perspective view; and

FIG. 12 is a perspective view of a cutting element with cutting edges at two surfaces having opposite directions of rotation.

### BEST MODE FOR CARRYING OUT THE INVENTION

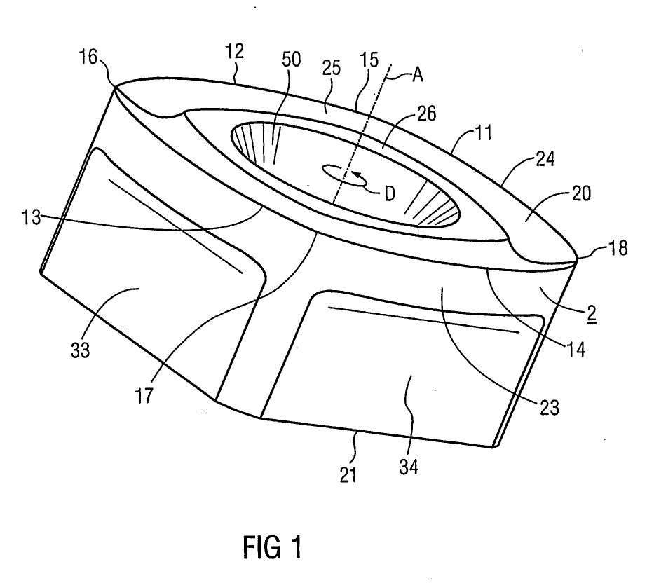

FIG. 1 shows a cutting element 2 with a first surface 20, which appears as the upper surface in FIG. 1, and a second surface 21 disposed on the opposite side, i.e. it is the undersurface in FIG. 1, as well as a lateral surface 23 that passes around the circumference of the element. Where the lateral surface 23 adjoins the first surface 20 there is a marginal region 24, which corresponds to the line of intersection between the surface 20 and the lateral surface 23. At this marginal region 24, which has an approximately quadratic basic shape, are provided four major cutting edges, mainly the cutting edges 11, 12, 13 and 14, each of which is separated from the next by the intermediate regions 15, 16, 17 and 18, which constitute the corner regions of the marginal region 24. The cutting edges 11, 12, 13 and 14 exhibit a four-fold symmetry with respect to an axis of rotation A that runs through an opening 50 disposed in the centre of the cutting element 2, so that when the latter is rotated by 90° the cutting edge 11 is congruent with the cutting edge 12, as is the cutting edge 12 with the cutting edge 13, the cutting edge 13 with the cutting edge 14, and the cutting edge 14 with the cutting edge 11. As a result, the cutting element 2 can be used four times, by rotating it about the axis A.

Each cutting edge 11 to 14 is convexly curved with respect to the rotational axis A, such that the curvature in the direction of rotation about the axis A that is indicated by D increases continuously or monotonically. For example, the curvature of the cutting edge 11 increases from the intermediate region 18 to the intermediate region 15, as does the curvature of the cutting edge 12 from the intermediate region 15 to the intermediate region 16, and so on.

On the first surface 20, next to the marginal region 24, an annular groove or recess 25 is provided, which is inclined at an acute angle towards the marginal region 24 and thus can form a sharp cutting edge. The opening 50 is enclosed by a surrounding area 26, which adjoins the recess 25 and has a flat, upwardly projecting surface. The opening 50 tapers towards the interior so that it has, for example, a conical or trumpet-like shape and thus is suitable to make contact with, or have pressed against it, the head of a fixation screw (not shown in FIG. 1) that is introduced through the opening 50 for the purpose of attaching the cutting element 2 to a tool. For attachment to the tool the cutting element 2 additionally comprises at the lateral surface 23, below the marginal region 24, four recesses or indentations that form four bearing surfaces, one under each of the cutting edges 11 to 14. In the view shown here only the bearing surfaces 33 and 34 can be seen. Each of the bearing surfaces, in particular 33 and 34, extends downward as far as the second surface 21, so that the cutting element can be moved downward, i.e. in the direction from the first surface 20 towards the second surface 21, and thus inserted into a seating on the tool body. The bearing surfaces, in particular 33 and 34, are planar and are preferably oriented parallel to the axis of rotation A.

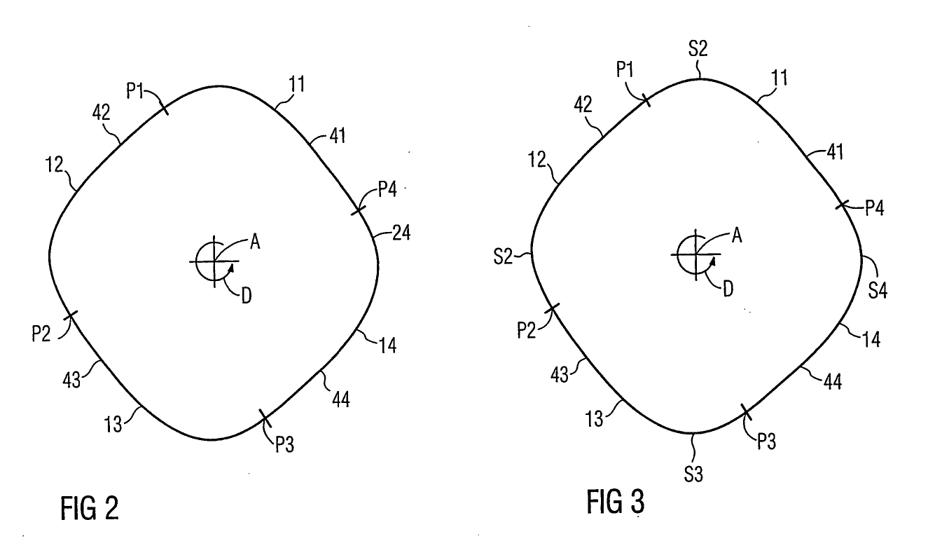

The convex, monotonically increasing curvature of the cutting edges 11 to 14 is produced in conformity with elementary functions, some examples of which are represented in FIGS. 2 to 5.

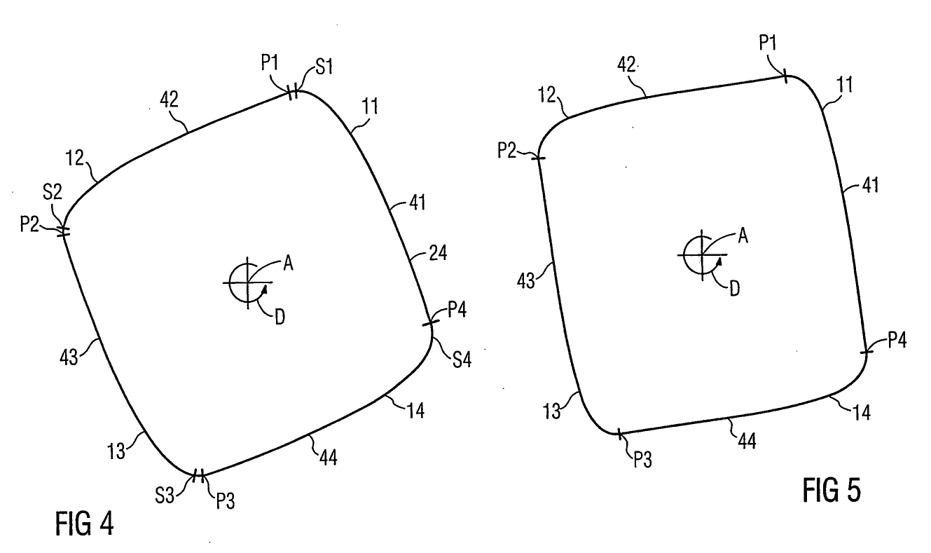

In FIG. 2 the marginal region 24 is composed of four curve sections 41 to 44, which are all identical to one another and merge smoothly with one another at the transition points P1 to P4. In the example shown in FIG. 2 the curve sections 41 to 44 have each been made elliptical, whereas in FIG. 3 the shape of each conforms to a hyperbola, in FIG. 4 to a parabola, and in FIG. 5 to a hyperbolic spiral.

In the example of the parabolic function according to FIG. 4, the transition points P1 to P4 are preferably located near the summit points S1 to S4 of the parabolas, i.e. the point in each curve at which the curvature is maximal.

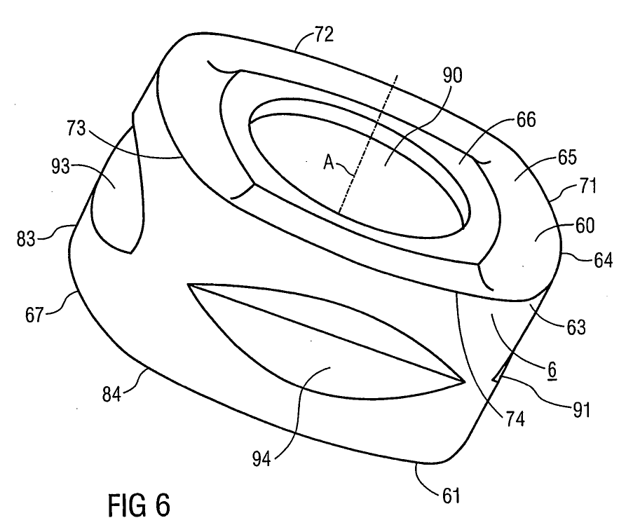

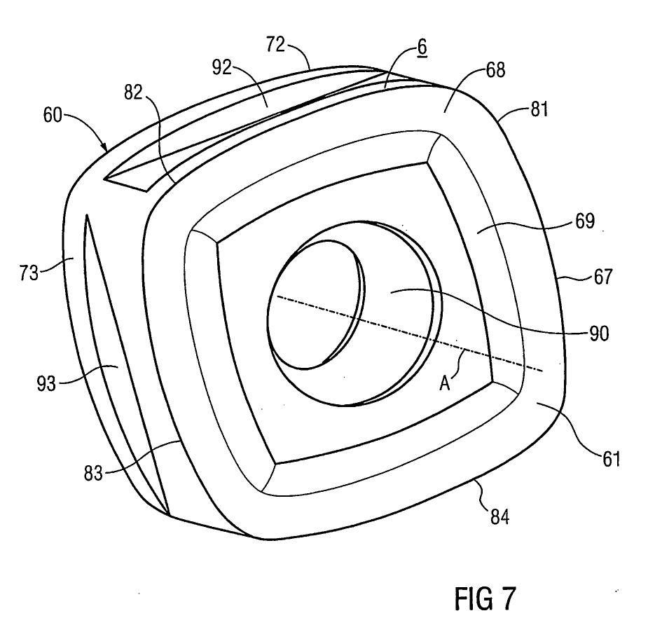

FIG. 6 and FIG. 7 each show an embodiment of a modified cutting element 6, which likewise has four cutting edges 71 to 74 in a marginal region 64 where a first surface 60 and a lateral surface 63 adjoin one another, but in addition has another four cutting edges 81 to 84 at the second surface 61. The two surfaces 60 and 61 with the marginal regions 64 and 67 are substantially symmetrical or similarly constructed, and in addition to the cutting edges again, in analogy to the embodiment shown in FIG. 1, comprise a recess 65 or 68, respectively, adjacent to the marginal region as well as a bearing surface 66 or 69, respectively, around the opening 90. Between the two surfaces 60 and 61, approximately in the middle of the lateral surface 63, a contact or bearing surface is formed for each cutting edge, i.e. four such surfaces in this case; in the example shown in FIG. 6, each contact surface has a V-shaped cross section formed by two slanted incision surfaces (only the contact surfaces 93 and 94 are visible here), whereas in the example shown in FIG. 7 the construction takes the form of grooves inset into the lateral surface 63, each of which has at its bottom a flat contact surface open to the exterior and oriented parallel to the tangential direction (of the four contact surfaces, only the two surfaces 92 and 93 are visible in FIG. 7).

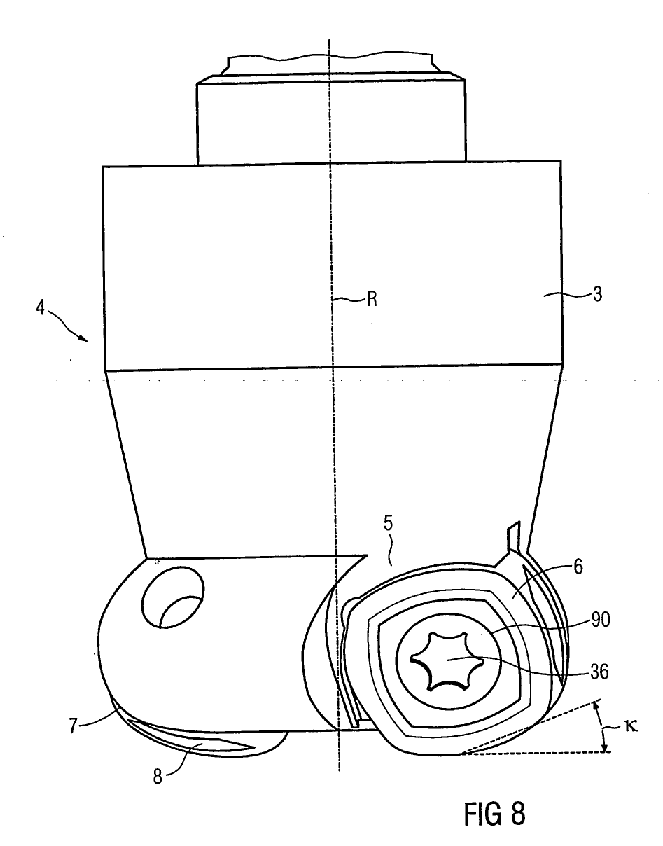

FIGS. 8 to 10 show a tool that operates by the removal of material, for example an end-milling cutter, with two cutting elements 6 and 8 that are constructed according to FIG. 8 and fixed to the tool head at its front end. The cutting elements 6 and 8 are offset from one another by about 180° with respect to the axis of rotation R of the tool, each being attached in an associated seating 5 or 7, respectively, of the carrier body 3 of the tool, by means of associated fixation screws 36 and 38. A projection 55 or 75, respectively, extends from the carrier body 3 into the recesses containing the contact surfaces, in order to assist the fixation and fitting of an element to the seating 5 or 7.

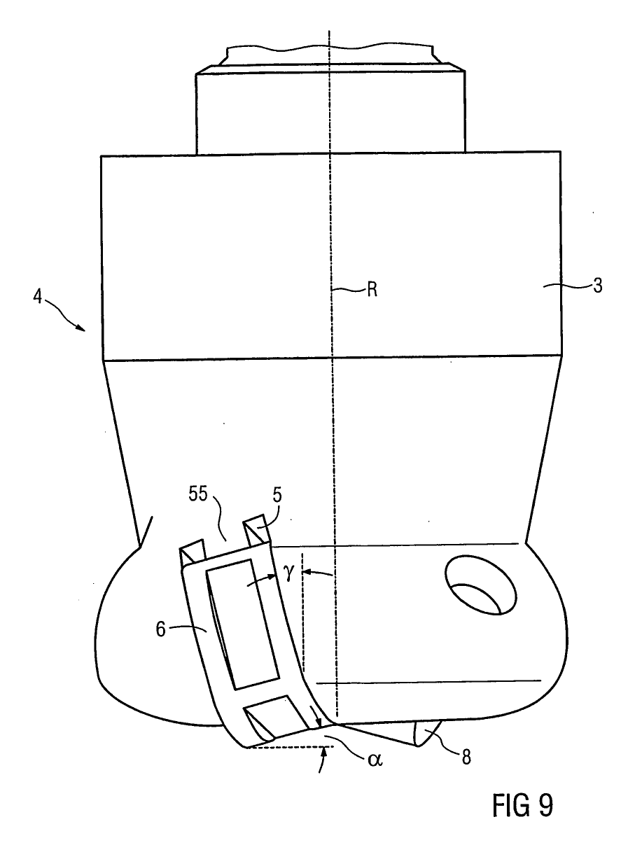

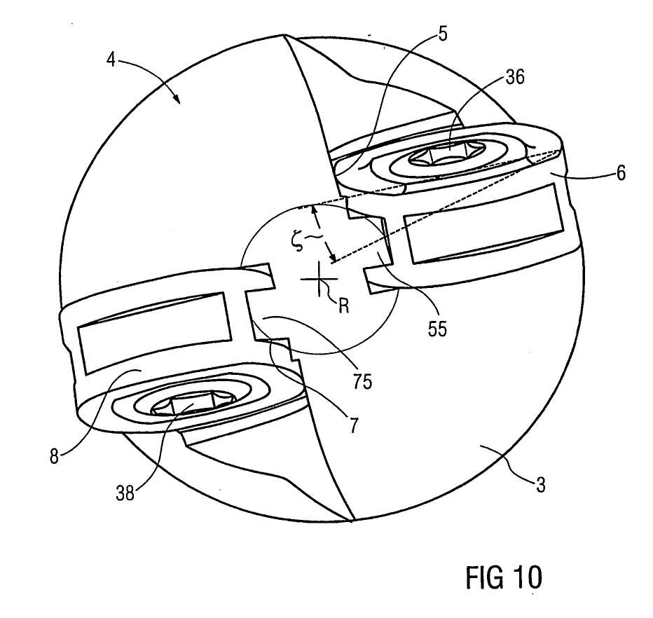

In FIG. 8 the setting angle is shown, in FIG. 9 the rake angle and the clearance angle, and in FIG. 10 the radial angle.

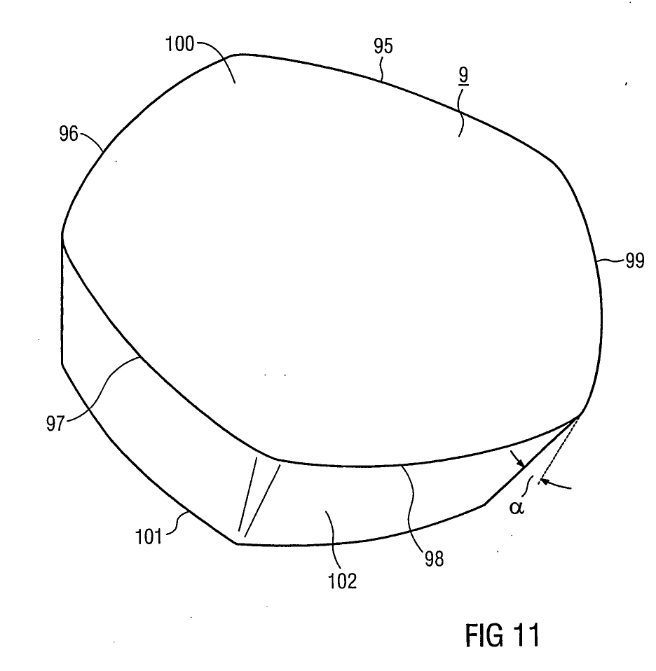

FIG. 11 shows a cutting element 9 with five cutting edges and hence five curve sections 95 to 99 on a flat, uninterrupted surface 100, which represents the face, and also with a surface 101 opposite thereto, which serves as bearing surface, as well as a lateral surface 102 situated between the first two surfaces. The cutting element 9 according to FIG. 11 is of the positive type, i.e. it comprises a clearance angle between the surface 100, with the cutting edges 95 to 99, and the lateral surface 102. In this embodiment the cutting element 9 does not include an opening for a screw, so that for attachment to a seating on the tool it is clamped by one or more wedge(s), in particular at the surface 100 and the surface 101.

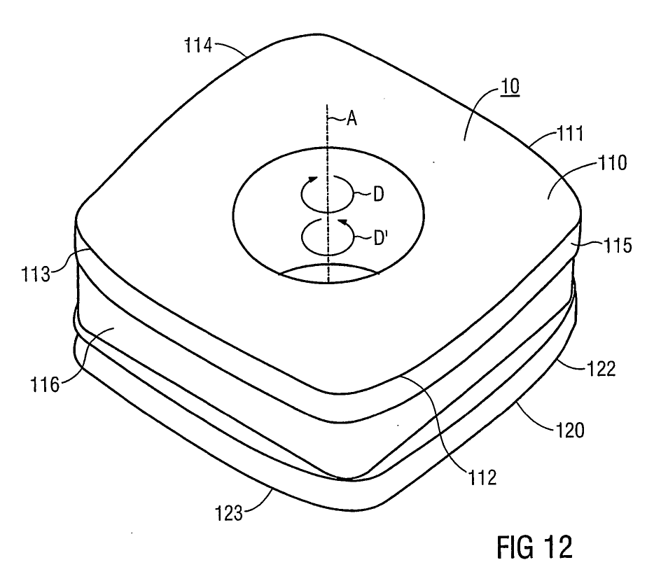

In FIG. 12 a cutting element 10 is shown that comprises two flat surfaces 110 and 120, connected to one another by a lateral surface 115, and a central opening 190 for a fixation screw. In the marginal region between the first surface 110 and the lateral surface 115 there are four identical cutting edges 111 to 114, the convex curvature of which increases in the clockwise direction, i.e. the direction of rotation D shown in the drawing. In the opposite marginal region, between the second surface 110 and lateral surface 115, another four identical cutting edges are formed, only two of which, 122 and 123, are visible here; the convex curvature of these cutting edges increases in the direction of rotation D′, which is opposite to the direction D, i.e. counterclockwise. The marginal region with the cutting edges 111 to 114 is continuous with the marginal region with the cutting edges 122 and 123 as well as two other cutting edges (not shown) in the case of rotation by 180° about an axis of rotation that is perpendicular to the axis A, i.e. two-fold reflection on mirror-image planes perpendicular to one another, so that for a given direction of rotation of the tool, in particular one according to FIGS. 8 to 10, about its tool axis, the cutting element 10 can be used four times by rotation through 180°.

The cutting element according to FIG. 12 is preferably designed for a tool that rotates to the left. For a tool that rotates to the right, the cutting edges would be reversed with respect to their curvature configuration, so that the directions of rotation D and D′ are effectively exchanged with one another.

The illustrated embodiments are only examples of the present invention and, therefore, are non-limitive. It is to be understood that many changes in the particular structure, materials, and features of the invention may be made without departing from the spirit and scope of the invention. Therefore, it is the Applicants' intention that its patent rights not be limited by the particular embodiments illustrated and described herein, but rather by the following claims interpreted according to accepted doctrines of claim interpretation, including the Doctrine of Equivalents and Reversal of Parts.

What is claimed is:

1. Cutting element comprising
a. a first surface and
b. at least one lateral surface,
c. wherein the lateral surface and the first surface adjoin one another in a marginal region,
d. and wherein the marginal region is composed of at least two curve sections that are arranged successively and are identical to on another,
e. wherein each of the identical curve sections is substantially convexly curved with reference to an axis of rotation that passes through the cutting element, and
f. wherein the curvature of each curve section increases strictly monotonically in a pre-specified rotational direction about the axis of rotation,
g. wherein the curve sections merge continuously with one another, and
h. wherein in each curve section there is disposed one cutting edge or each curve section corresponds substantially to a cutting edge.

2. Cutting element according to claim 1, in which each cutting edge is provided or employed as a major cutting edge.

3. Cutting element according to claim 1, in which in the marginal region there are at least two cutting edges constructed identical to one another, so that when the cutting element is turned about its axis of rotation by a pre-specified rotational angle, each cutting edge comes into a previous position of another cutting edge and is congruent to this other cutting edge.

4. Cutting element according to claim 1, in which the cutting edges are connected to one another by intermediate regions of the marginal region, such that the intermediate regions are not provided as main cutting edges and/or said regions comprise or are in particular corner regions, and such that in addition the cutting edges and the adjacent intermediate regions merge with one another continuously, preferably continuously differentially.

5. Cutting element according to claim 1, in which the curve sections merge with one another in a continuously differentiable manner.

6. Cutting element according to claim 1, in which the cutting edges or the curve sections of the marginal region are constructed so as to be smooth or continuously differentiable.

7. Cutting element according to claim 1, in which the cutting edges or the curve sections of the marginal region, at least in an orthogonal projection onto a projection plane perpendicular to the axis of rotation, are configured at least in part according to a section of an integral or fractional rational function, or are configured at least in part according to a section of a parabola, in which case preferably each cutting edge terminates at the summit of the parabola, or are configured at least in part according to a section of a hyperbola, in which case preferably each cutting edge terminates at the summit of the hyperbola.

8. Cutting element according to claim 1, in which the cutting edges or the curve sections of the marginal region, at least in an orthogonal projection onto a projection plane perpendicular to the axis of rotation, are configured at least in part according to a section of a cycloid, or an elliptical function, or a trigonometric function, in particular a tangent or sine function, or an exponential function, or a spiral, in particular a logarithmic spiral, a hyperbolic spiral or a spiral of Archimedes.

9. Cutting element according to claim 1, in which the cutting edges or the curve sections of the marginal region are composed of individual partial curves, which merge with one another in a continuous, preferably continuously differentiable, manner.

10. Cutting element according to claim 1, in which at least the marginal region has an at least approximately mirror-symmetric configuration with reference to a plane of symmetry that includes the axis of rotation, or is at least approximately axially symmetrical with respect to the axis of rotation.

11. Cutting element according to claim 1, with a second surface that faces away from the first surface and adjoins the lateral surface in an additional marginal region.

12. Cutting element according to claim 11, in which the marginal region formed by the second surface and the lateral surface comprises at least one cutting edge or at least two curve sections, such that each cutting edge or each curve section is substantially convexly curved with respect to an axis of rotation that passes through the cutting element, and the curvature of each cutting edge or each curve section increases strictly monotonically in a pre-specified rotational direction about the axis of rotation.

13. Cutting element according to claim 12, in which the rotational direction determining the curvature of the cutting edge(s) or curve sections at the additional marginal region formed by the second surface and the lateral surface is either the same as or opposite to the rotational direction at the marginal region formed by the first surface and the lateral surface.

14. Cutting element according to claim 11, in which the additional marginal region formed by the second surface and the lateral surface is substantially identical to the marginal region formed by the first surface and the lateral surface, in particular comprises the same number, arrangement and configuration of identical cutting edges or curve sections as does the first marginal region.

15. Cutting element according to claim 11, in which the additional marginal region formed by the second surface and the lateral surface is a mirror image of the first marginal region, with respect to a plane of mirror symmetry situated between the first surface and the second surface and oriented perpendicular to the axis of rotation.

16. Cutting element according to claim 11, in which the additional marginal region formed by the second surface and the lateral surface is represented by or originates from mirroring of the first marginal region with respect to a first mirror-symmetry plane situated between the first surface and the second surface and oriented perpendicular to the axis of rotation, and subsequent additional mirroring with respect to a second mirror-symmetry plane that contains the axis of rotation and/or subsequent rotation by 180° about an axis of symmetry oriented perpendicular to the axis of rotation.

17. Cutting element according to claim I 1, which is constructed so as to be substantially mirror-symmetric with respect to a plane of mirror symmetry situated between the first surface and the second surface and oriented perpendicular to the axis of rotation.

18. Cutting element according to claim 1, with at least one bearing surface, preferably a number of bearing surfaces corresponding to the number of cutting edges or curve sections, by way of which to make contact with a carrier body of a material-removing tool, or to make contact with a seating therein.

19. Cutting element according to claim 18 and claim 11, in which at least one or every bearing surface is constructed on the lateral surface between the two marginal regions and spaced apart from the marginal regions, or in which at least one or every bearing surface is constructed on the lateral surface and is spaced apart from the marginal region at the first surface, as well as extending as far as and opening into the marginal region at the second surface.

20. Cutting element according to claim 18 or claim 19, in which at least one or every bearing surface consists of one or more flat surfaces and/or in which every bearing surface is situated in a groove in the lateral surface that is inwardly offset from the from the surrounding lateral surface.

21. Cutting element according to claim 1, in which the lateral surface has a curved shape and in its curvature conforms at least substantially to the curvature of the marginal region at the first surface or at the second surface.

22. Cutting element according to claim 1, in which the marginal region at the first surface extend substantially in a plane, or in which the marginal region at the first surface and/or at the second surface comprises a bezel or chamfer.

23. Cutting element according to claim 1, with a central through-bore through which the axis of rotation passes, and which preferably serves as a passageway for a fixation means, in particular a fixation screw, with which to attach the cutting element to a carrier body of a material-removing tool.

24. Cutting element according to claim 1, in which the first surface and/or the second surface, within a region adjacent to the marginal region, extends within a solid angle range that is directed inward and/or towards the second and/or first surface and/or is inclined and/or is set at an acute angle with respect to the lateral surface in the marginal region and/or in which the first surface and/or the second surface comprises a circumferential recess or groove to guide chips away.

25. Cutting element according to claim 1, which can be multiply used, according to the number of cutting edges present at a marginal region, by rotating it about the axis of rotation.

26. Cutting element according to claim 1, in which while a workpiece is being machined by a cutting edge at the marginal region between the first or second surface and the lateral surface, the first or second surface serves as the face and the lateral surface, as the flank.

27. Cutting element according to claim 26, in which either a clearance angle is present between face and flank, or which is of the positive type, or in which no clearance angle is present between face and flank, or which is of the negative type.

28. Material-removing tool, in particular milling tool or end-milling cutter, with
a. a carrier body that rotates or can be rotated about a tool axis, with at least one seating for at least one cutting element; and
b. cutting element(s) according to one of the claims 1 to 27, which is or are attached, preferably releasably, to said seating(s).
